(19) United States
(12) Patent Application Publication
(10) Pub. No.: US 2017/0045135 A1
(43) Pub. Date: Feb. 16, 2017

(54) BEVEL GEAR DRIVE

(71) Applicant: SIEMENS AKTIENGESELLSCHAFT, 80333 München (DE)

(72) Inventors: JENS KIESENBAUER, Penig (DE); THOMAS LIEBIG, Dresden (DE); ROBERT SCHADE, Colditz (DE)

(73) Assignee: SIEMENS AKTIENGESELLSCHAFT, 80333 München (DE)

(21) Appl. No.: 15/304,395

(22) PCT Filed: Apr. 8, 2015
(86) PCT No.: PCT/EP2015/057578

§ 371 Date: Oct. 14, 2016

(30) Foreign Application Priority Data
Apr. 17, 2014 (EP) 14165139.8

(51) Int. Cl. F16H 57/04; F16H 57/021; F16H 57/038; F16H 1/14

(52) U.S. Cl. CPC F16H 57/0495; F16H 1/14; F16H 57/021; F16H 57/038; F16H 57/0471; F16H 57/0457

(57) ABSTRACT

A bevel gear drive includes an input shaft which includes an input bevel gear and has an input interface at one shaft end thereof. The input shaft is arranged vertically in operation and supported by a bearing at a side of the input bevel gear facing away from the input interface. An output shaft includes an output bevel gear in direct meshing engagement with the input bevel gear, with the output shaft being overhung-mounted and having an output interface at one shaft end thereof which faces away from the output bevel gear. Both, the input shaft and the output shaft are mounted in a drive housing.

The present invention relates to a bevel gear drive.

It is known to configure a bevel gear stage serving as a preliminary stage of a main drive with an overhung mounting of the input shaft, wherein the bearings of the input shaft are arranged on the driven shaft end of the input shaft, i.e. on the motor side. In the company publication “The Design of Rolling Bearing Mountings—Design Examples Covering Machines, Vehicles and Equipment” from Schaeffler Technologies GmbH & Co. KG, Schweinfurt, publication No. WL 00 200/5 DA, issued July 2011, under No. 29 on page 45, a bevel gear preliminary stage of a spur gear drive is shown.

A schematic representation of a known bevel gear stage of this type is shown in FIG. 1. The installation space occupied by the input shaft 11 and a drive motor (not shown) connected coaxially to the shaft end 17 is relatively large. If, in addition, as shown in FIG. 1, the input shaft 11 of the bevel gear stage driven by a motor is arranged standing upright, e.g. in order to keep the horizontal installation space occupied by the drive consisting of a motor and the gearing as small as possible, for lubrication of the bearings 15 of the input shaft 11, either grease lubrication must be used or oil lubrication ensured by one of the following measures: either a cost-increasing pressurized oil lubrication is provided or the oil level in the bevel gear stage is raised so far that the uppermost bearing 15 of the drive shaft 11 lies reliably in the oil bath. As a result of the structure of the bevel gear stage, in the latter case, the entire drive housing 19 must be filled with oil, which lessens the efficiency of the drive through churning losses.

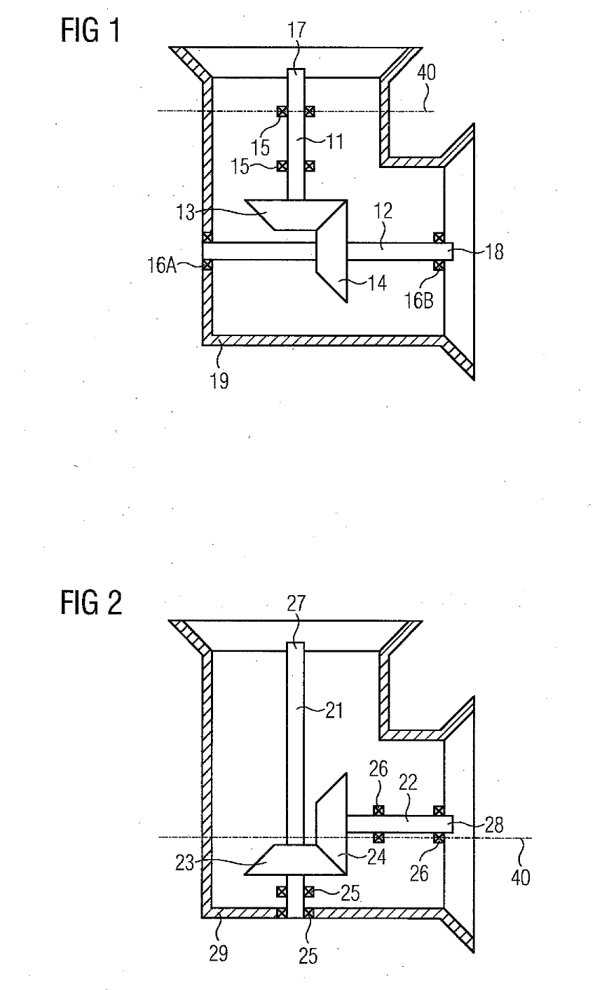

DE 102007061017 A1 (Schaeffler KG) 25 Jun. 2009, which is regarded as the closest prior art, describes, making reference to FIG. 2, an angular gear drive 5 in an all-wheel drive train of a motor vehicle. Herein, a pinion 3 is driven by a bevel gear 13 which is attached in a rotationally fixed manner to a hollow shaft 12. This hollow shaft 12 is connected to an output of a front axle differential transmission by means of a spline system 70. By means of the rotation of the pinion 3, a flange 4 connected in a rotationally fixed manner to a pinion shaft 2 carrying the pinion 3 integrally is also driven, said flange thus being able to drive an output shaft connectable thereto, for example a universally jointed shaft, leading to the rear axle.

It is an object of the invention to provide an improved bevel gear drive which can serve as a preliminary stage of a main drive connected downstream.

This object is solved with the features of claim 1.

The bevel gear drive according to the invention can serve as a preliminary stage of an industrial main drive. The bevel gear drive comprises an input shaft mounted on one side, having an input bevel gear and an overhung mounted output shaft with an output bevel gear which meshes with the input bevel gear. The bevel gear drive also comprises a drive housing in which the two shafts are mounted. The input shaft has, at one shaft end, an input interface for connecting to a drive motor. The input shaft is mounted in a bearing on the side of the input bevel gear facing away from the input interface. The output shaft has, at one end thereof facing away from the output bevel gear, an output interface for connecting to'a main drive

The expression “bevel gear” covers both a bevel gear and also a crown wheel. It is thus possible, for example, that the input shaft carries a bevel gear and the output shaft carries a crown wheel, or vice versa.

A drive unit, for example, a single-stage or multi-stage planet or spur gear drive can be connected upstream of a drive preliminary stage. If the drive apparatus formed from the preliminary stage and the drive unit is designated the “drive”, then the drive unit can be designated—in relation to the upstream drive preliminary stage—the “main drive”. In the present invention, the drive preliminary stage is configured in the form of a bevel gear drive. The main drive can be any desired drive, for example, a single-stage or multi-stage planetary or spur gear drive.

Similarly to the known bevel gear preliminary stage of a spur gear drive mentioned in the introduction, in the present invention also, the mounting of the drive shaft of the bevel gear drive serving as a drive preliminary stage is overhung; in contrast to the prior art, however, the mounting of the input shaft of the bevel gear drive is displaced to the other side of the meshing engagement. By means of the displacement of the mounting of the input shaft to the side of the input bevel gear facing away from the input interface, the motor can be brought significantly nearer to the drive; by this means, the installation space needed on the motor side is significantly reduced as compared with conventional drive bevel gear preliminary stages.

In addition to the advantage of the reduced installation space, the bevel gear drive is provided on both the input side and the output side with a respective interface solution. This allows the adaptation at the input of different motors with only one input shaft and at the output the use of different gearing ratios of the subsequent drive stage also with just one output shaft. These two interfaces significantly reduce the variety of parts on use of the bevel gear stage within a drive construction kit and thus also the costs of the drive solution.

The bevel gear drive according to the invention is preferably an industrial drive, i.e. configured according to the requirements of industry.

Advantageous embodiments of the invention are the subject matter of the dependent claims.

According to a preferred embodiment, the bearing of the input shaft comprises two roller bearings, i.e. the input shaft is double bearing mounted. The input shaft is therefore stably mounted. It is possible that the input shaft is mounted in a bearing shell with two bearings.

The bearing of the input shaft can be configured as a double tapered roller bearing in an X-arrangement. By this means, the advantage is achieved that, by means of the contact angle of the tapered roller bearing, the position of the virtual bearing site on the shaft moves closer to the meshing engagement. This lessens the shaft deformation which reduces the noise production and increases the reliability of the bevel gear toothing.

According to a preferred embodiment, the cone point of the toothing of the input bevel gear points in the direction toward the input interface. It is thereby achieved that the axial force arising from the meshing engagement of the input bevel gear in the output bevel gear and acting on the input shaft is directed in the direction toward the bearing of the input shaft. Thus, this axial force can be absorbed in the bearing of the input shaft arranged, in relation to the input bevel gear, opposite the input interface.

According to a preferred embodiment, the input shaft is arranged vertically in operation and the output shaft is arranged horizontally in operation. It is particularly advantageous in this case if the input interface is directed vertically upwardly, i.e. lies vertically over the input bevel gear. By this means, with the motor standing upright, the bearing of the input shaft lies vertically below the input bevel gear and thus in the oil bath and the lubrication is therefore already ensured for the normal oil level of the overall drive. This reduces the losses in the drive and thus increases the efficiency of the drive. Only with an arrangement of the motor underneath would the problem of lubricant supply to the input shaft bearing arise again; however, this arrangement is virtually irrelevant for practical use.

According to a preferred embodiment, with a vertically positioned input shaft, in operation of the bevel gear drive, the drive housing is filled as far as bearings of the horizontally arranged output shaft with liquid lubricant, in particular lubrication oil. By means of the greatly reduced oil level in comparison with previously known bevel gear preliminary stages, the churning losses are reduced and the drive efficiency level is increased.

According to a preferred embodiment, the input shaft is arranged vertically in operation, the input interface is oriented vertically upwardly and the toothing of the input bevel gear faces vertically upwardly. In this case, both the bearings of the input shaft and of the output shaft as well as the meshing engagement of the input bevel gear in the output bevel gear are lubricated if the oil level in the bevel gear preliminary stage is selected to be so high that the bearings of the horizontally extending output shaft are immersed in the oil bath.

According to a preferred embodiment, the input shaft bears at least one add-on part on the side of the bearing facing away from the input bevel gear, in particular one or more of the following add-on parts: a pump, a reverse motion block, a ventilator, a brake, a sensor for determining the position of the input shaft. By this means, the free shaft end which the input shaft of the bevel gear drive according to the invention possesses is used for mounting add-on parts, i.e. additional components; herein, the rotation energy provided by the input shaft can be used to drive these add-on parts. Since this is the input shaft of the drive which is subjected to the highest rotary speeds and the lowest torque, the add-on parts can accordingly be dimensioned smaller than would be possible with intermediate shafts.

According to a preferred embodiment, the add-on part is arranged outside the drive housing. By this means, add-on parts of relatively large structural size or add-on parts which must come into contact with the surroundings, for example ventilators, can also be mounted.

An advantageous embodiment of the invention is formed by a drive which comprises a bevel gear drive according to the invention as a preliminary stage and a main drive arranged downstream of the bevel gear drive, wherein the main drive is coupled to the bevel gear drive via the output interface of the bevel gear drive. Herein, the output interface can be configured so that the part of the drive housing surrounding the output shaft has a mounting flange for mounting the main drive. Preferably, the main drive is connected directly downstream of the bevel gear drive, i.e. the output shaft of the bevel gear drive is connected, without a drive stage connected therebetween, to the input shaft of the main drive.

According to a preferred embodiment of the drive, the main drive is configured as a single-stage or multi-stage planetary drive.

It is advantageous to equip a geared motor comprising a motor and a drive with a drive as described above, wherein the motor is coupled via the input interface to the bevel gear drive. Herein, the input interface can be configured so that the part of the drive housing surrounding the input shaft has a mounting flange on the end side for mounting the motor.

According to a preferred embodiment of the geared motor, a rotor shaft of the motor is connected via a coupling piece to the vertically upward end of the input shaft of the bevel gear drive.

It is advantageous, for operating the bevel gear drive as described above, i.e. with an input shaft which is arranged vertically in operation, to fill the drive housing as far, when the bevel gear drive is in operation, as bearings of the horizontally arranged output shaft with lubricant, in particular lubrication oil. By means of the greatly reduced oil level in the bevel gear drive in comparison with previously known bevel gear preliminary stages, the churning losses are reduced and the drive efficiency level is increased.

The above-described properties, features and advantages of this invention and the manner in which these are achieved will now be described more clearly and intelligibly in relation to exemplary embodiments, and illustrated in detail by reference to the drawings. In the drawings:

FIG. 1 is a schematic illustration in section of a known bevel gear drive as a bevel gear preliminary stage of a main drive,

FIG. 2 is a schematic illustration in section of a preferred embodiment of a bevel gear drive as a bevel gear preliminary stage of a main drive,

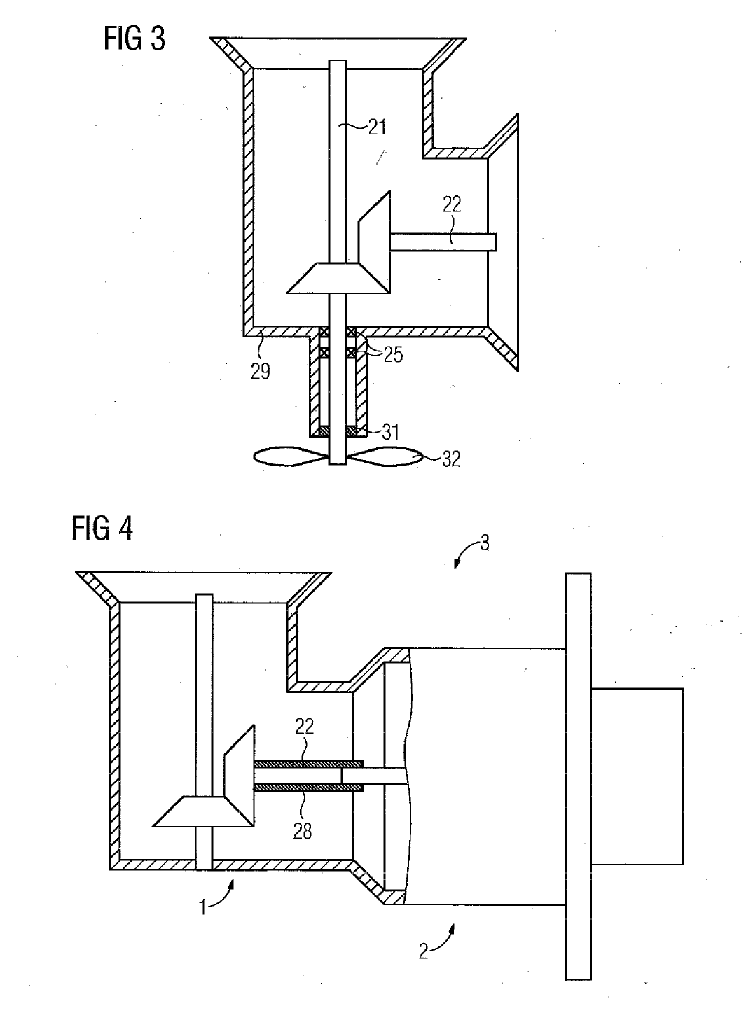

FIG. 3 is a schematic illustration in section of a bevel gear drive with an add-on ventilator,

FIG. 4 is a schematic illustration of a planetary drive with a bevel gear drive serving as a preliminary stage,

FIG. 5 is a schematic illustration of a geared motor, and

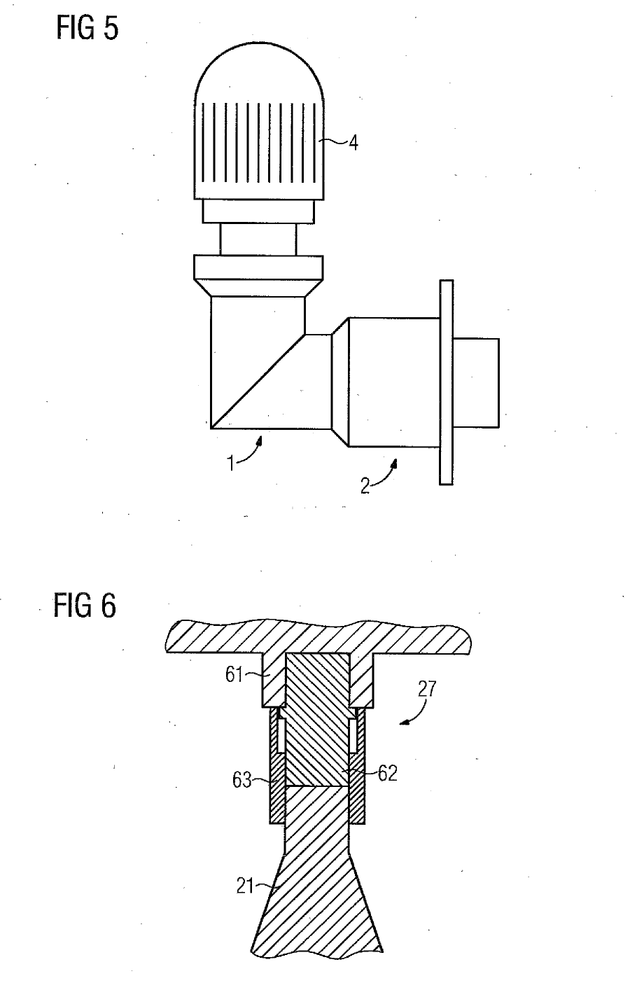

FIG. 6 is a section through an input interface.

FIG. 1 shows a bevel gear preliminary stage of a drive, as known from the prior art. The bevel gear preliminary stage has an overhung mounted input shaft 11 with an input bevel gear 13, an output shaft 12 with an output bevel gear 14 in meshing engagement with the input bevel gear 13 and a drive housing 19 in which the two shafts 11, 12 are mounted. The bevel gear preliminary stage is arranged during its operation so that the input shaft 11 is arranged vertically and the output shaft 12 is arranged horizontally.

The input shaft 11 is connected at its vertically upper end 17 to a drive motor. The bearings 15 of the input shaft 11 are arranged thereunder and the input bevel gear 13 is arranged vertically beneath the bearing 15 on the input shaft 11. The cone point of the toothing of the input bevel gear 13 herein points vertically downwardly. The output shaft 12 is mounted at both ends in bearings 16A, 16B, i.e. on both sides of the output bevel gear 14. The output shaft 12 is connected at one end 18 to a drive main stage.

In order to ensure sufficient lubrication of all the lubrication points of the bevel gear preliminary stage, i.e. also the bearings 15 arranged at the motor-side end of the input shaft 11, the lubrication oil level 40 in the drive housing 19 must reach as far as the vertically uppermost bearing 15.

FIG. 2 shows a bevel gear drive according to the invention which serves as a bevel gear preliminary stage of a main drive. The bevel gear preliminary stage has an overhung mounted input shaft 21 with an input bevel gear 23, an output shaft 22 with an output bevel gear 24 in meshing engagement with the input bevel gear 23 and a drive housing 29 in which the two shafts 21, 22 are mounted. The bevel gear drive is arranged during its operation so that the input shaft 21 is arranged vertically and the output shaft 22 is arranged horizontally.

The input shaft 21 has an input interface 27 at its vertically upper end 27, by means of which it can be connected to a drive motor. Herein, the drive motor has a vertical rotor shaft position. The input bevel gear 23 is arranged thereunder on the input shaft 21. The bearings 25 of the input shaft 21 are arranged under the input bevel gear 23. The cone point of the toothing of the input bevel gear 23 herein points vertically upwardly. The output shaft 22 has, at the end thereof facing away from the output bevel gear 24, an output interface 28 for connecting to a main drive, for example, a planetary drive. The output shaft 22 is mounted overhung in bearings 26 arranged between the output bevel gear 24 and the output interface 28. The oil-tight sealing of the bearing site 25 at the vertically lower end of the input shaft can take place with the aid of seals as are known to persons skilled in the art, for example, with the aid of a pressure tube.

In order to ensure sufficient lubrication of all the lubrication sites of the bevel gear drive, it is sufficient with the bevel gear drive according to the invention if the lubricating oil level 40 in the drive housing 29 reaches as far as the vertically lower edge of the bearings 26 of the horizontally arranged output shaft 22. This lower oil level 40 as compared with the situation shown in FIG. 1 is possible due to the displacement according to the invention of the bearings 25 of the input shaft 21 to a position vertically below the input bevel gear 23.

FIG. 3 shows a preferred development of a bevel gear drive according to the invention as a preliminary stage of a main drive. Herein, at the end of the input shaft 21 lying opposite the input interface, said input shaft is elongated vertically downwardly beyond the bearings 25 far enough that sufficient assembly space is provided to arrange a reverse motion block 31 within the drive housing 29 and to arrange a ventilator rotor 32 on the input shaft 21 outside the drive housing 29.

FIG. 4 shows a planetary drive 3, comprising a planetary main drive 2 and a bevel gear drive 1 as a bevel gear preliminary stage. Herein, the planetary main drive 2 is coupled via the output interface 28 to the bevel gear drive 1. The planetary main drive 2 can comprise one or more coaxially mounted planetary stages which are mounted in a dedicated, preferably cylindrical, housing.

It is possible that the coupling is configured as a toothed coupling. The output shaft 22 of the bevel gear drive is configured as a hollow shaft onto the planet-side end of which an internal toothing is arranged. The planetary main drive 2 comprises an input shaft with a corresponding external toothing.

FIG. 5 shows a geared motor, comprising a motor 4, a bevel gear preliminary stage 1 and a planetary main drive 2. Herein, the motor 4 is coupled via an input interface to the bevel gear preliminary stage 1. As FIG. 6 shows, the input interface provides a connection for conjoint rotation between a rotor shaft 61 of the motor 4 and the input shaft 21 of the bevel gear preliminary stage 1. The input shaft 21 is herein configured as an externally toothed solid shaft and the rotor shaft 61 as an internally toothed hollow shaft. An externally toothed pin 62 is placed on the end side of the input shaft 21 and is connected to the input shaft 21 for conjoint rotation by means of a pushed-over internally toothed sleeve-shaped coupling piece 63. The pin 62 engages, in turn, with its external toothing in the internal toothing of the motor hollow shaft 61. By means of differently dimensioned pins 62, it is readily possible to create conjointly rotating connections between the bevel gear preliminary stage and motors of different types.

Alternatively, a commercially available journal with a keyway can be used, as is commonplace with IEC motors. In this case, a different form must merely be provided for the coupling piece 63. This then has a keyed connection on the motor side and on the output side, a further internal toothing.

1.-12. (canceled)

13. A bevel gear drive, comprising:
an input shaft including an input bevel gear and having an input interface at one shaft end thereof, said input shaft being arranged vertically in operation;
a bearing for supporting the input shaft at a side of the input bevel gear facing away from the input interface;
an output shaft including an output bevel gear in direct meshing engagement with the input bevel gear, said output shaft being overhung-mounted and having an output interface at one shaft end thereof which faces away from the output bevel gear; and
a drive housing in which the input shaft and the output shaft are mounted.

14. The bevel gear drive of claim 13, wherein the input bevel gear has a toothing with a cone point which points toward the input interface.

15. The bevel gear drive of claim 13, wherein the input interface is directed vertically upwardly, and the output shaft is arranged horizontally in operation.

16. The bevel gear drive of claim 13, further comprising a bearing assembly, said output shaft extending horizontally and supported by the bearing assembly, said drive housing being filled with liquid lubricant during operation of the bevel gear drive up to a level of the bearing assembly.

17. The bevel gear drive of claim 13, wherein the input shaft carries at least one add-on part on a side of the bearing facing away from the input bevel gear.

18. The bevel gear drive of claim 17, wherein the at least one add-on part is a member selected from the group consisting of a pump, a reverse motion block, a ventilator, a brake and a sensor for determining the position of the input shaft.

19. The bevel gear drive of claim 17, wherein the at least one add-on part is arranged outside the drive housing.

20. A drive, comprising:
a bevel gear drive comprising an input shaft including an input bevel gear and having an input interface at one shaft end thereof, said input shaft being arranged vertically in operation, a bearing for supporting the input shaft at a side of the input bevel gear facing away from the input interface, an output shaft including an output bevel gear in direct meshing engagement with the input bevel gear, said output shaft being overhung-mounted and having an output interface at one shaft end thereof which faces away from the output bevel gear, and a drive housing in which the input shaft and the output shaft are mounted; and
a main drive connected downstream of the bevel gear drive, said main drive being coupled via the output interface of the output shaft to the bevel gear drive.

21. The drive of claim 20, wherein the main drive is a planetary drive.

22. The drive of claim 20, wherein the input bevel gear has a toothing with a cone point which points toward the input interface.

23. The drive of claim 20, wherein the input interface is directed vertically upwardly, and the output shaft is arranged horizontally in operation.

24. The drive of claim 20, wherein the bevel gear drive includes a bearing assembly, said output shaft extending horizontally and supported by the bearing assembly, said drive housing being filled with liquid lubricant during operation of the bevel gear drive up to a level of the bearing assembly.

25. The drive of claim 20, wherein the input shaft carries at least one add-on part on a side of the bearing facing away from the input bevel gear.

26. The drive of claim 25 wherein the at least one add-on part is a member selected from the group consisting of a pump, a reverse motion block, a ventilator, a brake and a sensor for determining the position of the input shaft.

27. The bevel gear drive of claim 25, wherein the at least one add-on part is arranged outside the drive housing.

28. A geared motor, comprising:
a drive comprising a bevel gear drive which includes an input shaft including an input bevel gear and having an input interface at one shaft end thereof, said input shaft being arranged vertically in operation, a bearing for supporting the input shaft at a side of the input bevel gear facing away from the input interface, an output shaft including an output bevel gear in direct meshing engagement with the input bevel gear, said output shaft being overhung-mounted and having an output interface at one shaft end thereof which faces away from the output bevel gear, and a drive housing in which the input shaft and the output shaft are mounted, and a main drive connected downstream of the bevel gear drive, said main drive being coupled via the output interface of the output shaft to the bevel gear drive; and
a motor coupled via the input interface of the input shaft to the bevel gear drive.

29. The geared motor of claim 28, wherein the motor has a rotor shaft, and further comprising a coupling piece configured to connect the rotor shaft to a vertically upper end of the input shaft of the bevel gear drive.

30. A method for operating a bevel gear drive which comprises an input shaft including an input bevel gear and having an input interface at one shaft end thereof, said input shaft being arranged vertically in operation, a bearing for supporting the input shaft at a side of the input bevel gear facing away from the input interface, a horizontally extending output shaft including an output bevel gear in direct meshing engagement with the input bevel gear, said output shaft being overhung-mounted and having an output interface at one shaft end thereof which faces away from the output bevel gear, and a drive housing in which the input shaft and the output shaft are mounted, said method comprising filling the drive housing with liquid lubricant during operation of the bevel gear drive up to a level of a bearing assembly to support the output shaft.
